(19) United States
(12) Patent Application Publication
(10) Pub. No.: US 2019/0315078 A1
(43) Pub. Date: Oct. 17, 2019

(54) METHOD FOR MAKING A MOLDED COMPOSITE OF A PREPREG SHEET AND A MOLDING MATERIAL

(71) Applicant: Advanced International Multitech Co., Ltd., Kaohsiung City (TW)

(72) Inventors: Chang-Hung TSAI, Kaohsiung City (TW); Chia-Hsing WU, Kaohsiung City (TW)

(21) Appl. No.: 16/131,746

(22) Filed: Sep. 14, 2018

(30) Foreign Application Priority Data
Apr. 11, 2018 (TW) 107112357

(51) Int. Cl. B29C 70/46

(52) U.S. Cl. CPC B29C 70/46

(57) ABSTRACT

A method for making a molded composite of a prepreg sheet and a molding material includes steps of: a) providing a mold assembly, b) disposing the molding material, c) placing the prepreg sheet, d) combining a female mold and a male mold of the mold assembly, and e) operating an actuating member to press the molding material against the prepreg sheet.

### CROSS-REFERENCE TO RELATED APPLICATION

This application claims priority of Taiwanese Application No. 107112357, filed on Apr. 11, 2018.

### FIELD

The disclosure relates to a method for making a molded composite, and more particularly to a method for making a molded composite of a prepreg sheet and a molding material.

### BACKGROUND

Structural components made from prepreg are widely used as housings and/or other constituent parts of various products in view of the lightweight and high strength characteristics of the prepreg. A plurality of prepreg layers are usually laminated together to form a prepreg laminate, followed by hot pressing the prepreg laminate in a mold to form a molded component. However, a structural component having a complicated profile cannot be made merely using the prepreg laminate. Therefore, a molding material such as a bulk molding compound or a sheet molding compound is usually used to form a part of the structural component having a complicated contour, which is then composited with the prepreg laminate via molding to form a molded composite.

Referring to FIG. 1, in a conventional method for making the molded composite of the prepreg laminate 21 and the molding material 22, a mold 1 is provided, which includes a female mold part 11 defining a cavity 110 and a male mold part 12 defining a recess 120. The prepreg laminate 21 composed of a plurality of prepreg layers is placed in the cavity 110 of the female mold part 11. The molding material 22 (e.g., the bulk molding compound) is then placed on the prepreg laminate 21 and in alignment with the recess 120 of the male mold part 12. The male mold part 12 and the female mold part 11 are combined with each other to permit the molding material 22 to be disposed within the recess 120 of the male mold part 12. The molding material 22 and the prepreg laminate 21 are hot-pressed to form the molded composite 3.

Since a compression force is applied on the male mold part 12 and/or the female mold part 11 to permit them to be combined with each other, the compression force specifically applied onto the molding material 22 in the recess 120 of the male mold part 12 cannot be adjusted according to the volume of the molding material 22 in the recess 120. When the volume of the molding material 22 is larger than the capacity of the recess 120, an excess of the molding material 22 will overflow from the recess 120 during combination of the male mold part 12 with the female mold part 11. The molded composite 3 thus made will have an inferior appearance quality. On the other hand, when the volume of the molding material 22 is smaller than the capacity of the recess 120, the molding material 22 cannot be sufficiently pressed against the prepreg laminate 21 during combination of the male mold part 12 with the female mold part 11, therefore, the molding material 22 and the prepreg laminate 21 of the molded composite 3 cannot be firmly bonded to each other and the thus obtained molded composite 3 will also have an inferior appearance quality.

### SUMMARY

Therefore, an object of the disclosure is to provide a method for making a molded composite of a prepreg sheet and a molding material to overcome the aforementioned shortcomings of the prior art.

According to an aspect of the disclosure, there is provided a method for making a molded composite of a prepreg sheet and a molding material. The method comprises steps of:

a) providing a mold assembly including
a female mold including a female mold body having a first outer surface and a first inner surface which is opposite to the first outer surface and which has a mold cavity extending toward the first outer surface to terminate at a sheet-side region,
a male mold including a male mold body having a second outer surface and a second inner surface which is opposite to the second outer surface and which has a pressing side region configured, in cooperation with the sheet side region to permit the prepreg sheet to be sandwiched therebetween, the pressing side region having at least one bore extending toward the second outer surface to terminate at a bore end and having a shape simulating that of the molding material, the second outer surface having at least one guiding channel extending to access to the bore end of the at least one bore, and
at least one pressing unit including
   a plunger which has an engaging end and an actuated end opposite to each other and which is guided by the guiding channel to permit the engaging end to move toward the bore, and
   an actuating member configured to press the actuated end of the plunger;

b) disposing the molding material in the at least one bore;

c) interposing the prepreg sheet between the sheet side region of the female mold and the pressing side region of the male mold;

d) combining the female mold with the male mold to permit the prepreg sheet to be sandwiched between the sheet side region of the female mold and the pressing side region of the male mold; and

e) operating the actuating member to press the actuated end of the plunger so as to move the plunger toward the female mold, thereby permitting the engaged end of the plunger to press the molding material against the prepreg sheet.

According to another aspect of the disclosure, there is provided a molded composite made by the method according to the disclosure.

### BRIEF DESCRIPTION OF THE DRAWINGS

Other features and advantages of the disclosure will become apparent in the following detailed description of the embodiment (s) with reference to the accompanying drawings, of which:

FIG. 1 is a schematic sectional view illustrating a conventional method for making a molded composite;

FIG. 2 is a schematic flow diagram of a first embodiment of a method for making a molded composite of a prepreg sheet and a molding material according to the disclosure;

FIG. 3 is a schematic sectional view of a mold assembly used for the first embodiment;

FIG. 4 is the mold assembly of FIG. 3 in a combination state;

FIG. 5 is a schematic sectional view of the molded composite made by the first embodiment;

FIG. 6 is a schematic sectional view of a mold assembly used for a second embodiment of a method for making a molded composite of a prepreg sheet and a molding material according to the disclosure; and

FIG. 7 is a schematic sectional view of a mold assembly used for a third embodiment of a method for making a molded composite of a prepreg sheet and a molding material according to the disclosure.

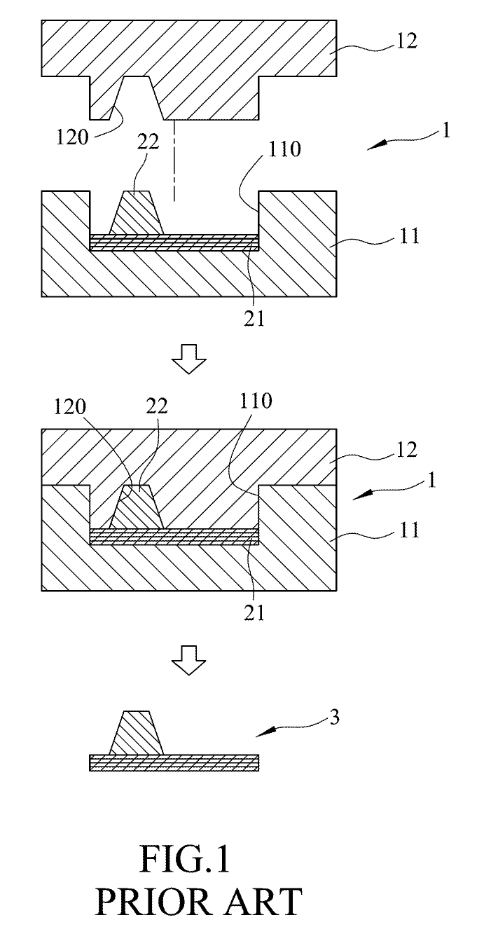

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

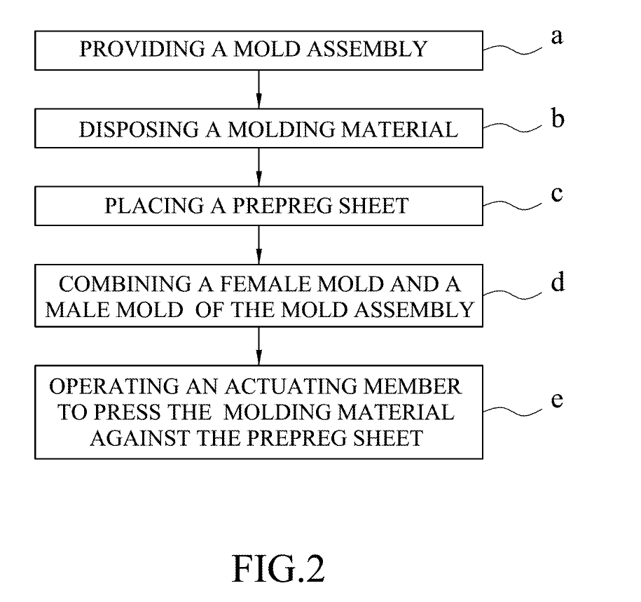

Referring to FIGS. 2, 3, and 4, a first embodiment of a method for making a molded composite 7 of a prepreg sheet 62 and a molding material 61 according to the disclosure comprises steps of:

a) providing a mold assembly 5;

b) disposing the molding material 61;

c) placing the prepreg sheet 62;

d) combining a female mold 51 and a male mold 52 of the mold assembly 5; and

e) operating an actuating member 527 to press the molding material 61 against the prepreg sheet 62.

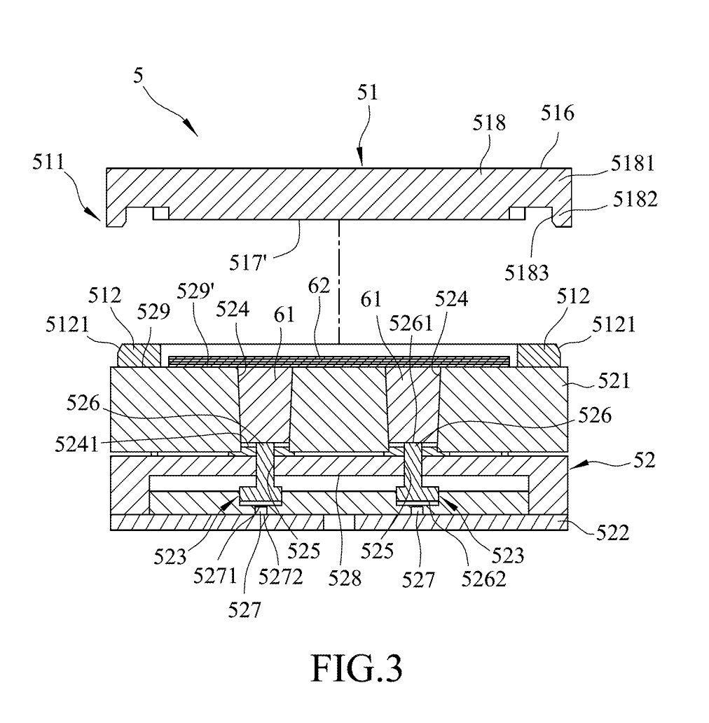

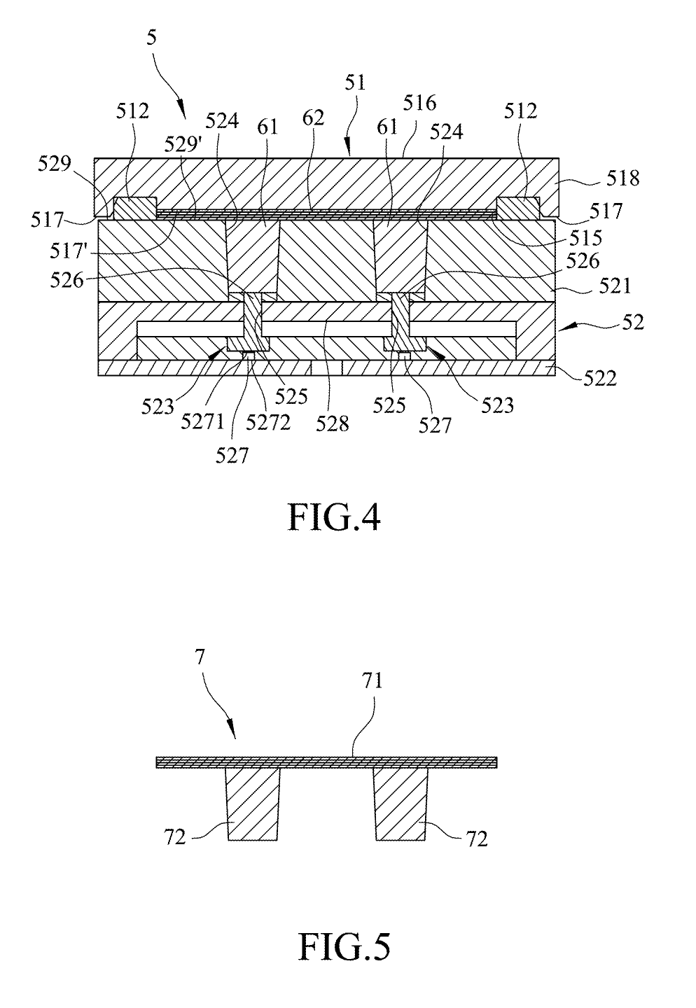

In step a), the mold assembly 5 is provided, which includes a female mold 51, a male mold 52, and at least one pressing unit 523. Two of the pressing units 523 are illustrated in FIGS. 3 and 4.

The female mold 51 includes a female mold body 511 having a first outer surface 516 and a first inner surface 517 opposite to the first outer surface 516. The first inner surface 517 has a mold cavity 515 extending toward the first outer surface 516 to terminate ata sheet-side region 517′.

The male mold 52 includes an abutment plate 522, and a male mold body 521 having a second outer surface 528 and a second inner surface 529 opposite to the second outer surface 528. The second inner surface 529 has a pressing side region 529′ which is configured, in cooperation with the sheet side region 517′ to permit the prepreg sheet 62 to be sandwiched therebetween. The pressing side region 529′ has at least one bore 524 extending toward the second outer surface 528 to terminate at a bore end 5241 and having a shape simulating that of the molding material 61. Two of the bores 524 are illustrated in FIGS. 3 and 4. The second outer surface 528 has at least one guiding channel 525 extending to access to the bore end 5241 of the at least one bore 524. Two of the guiding channels 525 are illustrated in FIGS. 3 and 4.

The female mold body 511 includes at least one pair of sliding blocks 512 and a cover 518.

The sliding blocks 512 are to be disposed on the second inner surface 529 of the male mold body 521 and spaced apart from each other by a predetermined distance which is slightly larger than a dimension of the prepreg sheet 62. Each of the sliding blocks 512 has an outer cam surface 5121. The female mold body 511 may include two pairs of the sliding blocks 512 configured in cooperation with each other to surround the prepreg sheet 62 to be placed on the second inner surface 529 of the male mold body 521.

The cover 518 includes a cover body 5181 having the first outer surface 516 and at least one pair of marginal extensions 5182 extending from opposite ends of the cover body 5181. Each of the marginal extensions 5182 has an inner cam surface 5183 configured to mate with the outer cam surface 5121 such that when the cover 518 moves toward the second inner surface 529 of the male mold body 521, the sliding blocks 512 are moved to abut against the prepreg sheet 62 by the marginal extensions 5182.

Each of the pressing units 523 includes a plunger 526 and an actuating member 527. The plunger 526 has an engaging end 5261 and an actuated end 5262 opposite to each other, and is guided by a corresponding one of the guiding channels 525 to permit the engaging end 5261 to move toward a corresponding one of the bores 524. The actuating member 527 is configured to press the actuated end 5262 of the plunger 526. The actuating member 527 has an inner end 5271 to engage the actuated end 5262 of the plunger 526 and an outer end 5272 opposite to the inner end 5271. The actuating member 527 suitable for the embodiment may be a hydraulic rod, a resilient member, or the like.

In step b), the molding material 61 is disposed in the bores 524. The molding material 61 may be a bulk molding compound or a sheet molding compound.

In step c), the prepreg sheet 62 is interposed between the sheet side region 517′ of the female mold 51 and the pressing side region 529′ of the male mold 52. Specifically, step c) is implemented after step b) by placing the prepreg sheet 62 on the pressing side region 529′ of the male mold body 521.

In step d), the female mold 51 is combined with the male mold 52 to permit the prepreg sheet 62 to be sandwiched between the sheet side region 517′ of the female mold 51 and the pressing side region 529′ of the male mold 52. Specifically, step d) is implemented by disposing the sliding blocks 512 on the second inner surface 529 of the male mold body 521 prior to placing of the prepreg sheet 62, and subjecting the cover 518 to move toward the second inner surface 529 of the male mold body 521 after placing of the prepreg sheet 62 to permit the sliding blocks 512 to be moved to abut against the prepreg sheet 62 by the marginal extensions 5182.

Alternatively, step d) may be implemented by disposing the sliding blocks 512 on the second inner surface 529 of the male mold body 521 after placing of the prepreg sheet 62, and subjecting the cover 518 to move toward the second inner surface 529 of the male mold body 521 after placing of the prepreg sheet 62 to permit the sliding blocks 512 to be moved to abut against the prepreg sheet 62 by the marginal extensions 5132.

In step e), the actuating member 527 is operated to press the actuated end 5262 of the plunger 526 so as to move the plunger 526 toward the female mold 51, thereby permitting the engaging end 5261 of the plunger 526 to press the molding material 61 against the prepreg sheet 62. The molding material 61 and the prepreg sheet 62 are thereby bonded to each other via hot pressing so as to make the molded composite 7. Specifically, the abutment plate 522 is configured to abut against the outer end 5272 of the actuating member 527 so as to facilitate implementation of step e).

As described above, the plunger 526 is guided by a corresponding one of the guiding channels 525 to permit the engaging end 5261 thereof to move toward a corresponding one of the bores 524 and the actuating member 527 is configured to press the actuated end 5262 of the plunger 526. Therefore, when step e) is implemented, the space of each of the bores 524 for receiving the molding material 61 can be adjusted accordingly to permit the molding material 61 to be fittingly disposed in each of the bores 524 and to be firmly bonded to the prepreg sheet 62 so as to avoid the aforesaid shortcomings of the prior art.

Referring specifically to FIG. 5, the molded composite 7 made by the first embodiment includes a base 71 which is made from the prepreg sheet 62, and at least one protrusion 72 which is made from the molding material 61 and which is bonded to the base 71. Two of the protrusions 72 are illustrated in FIG. 5.

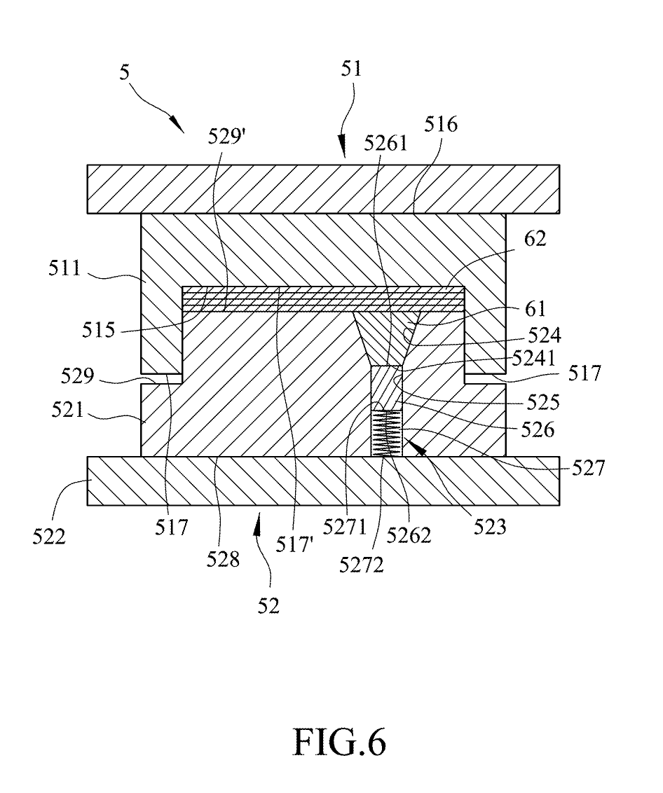

Referring to FIG. 6, a second embodiment of a method for making the molded composite 7 of the prepreg sheet and the molding material 61 according to the disclosure is similar to the first embodiment except that the mold assembly 5 illustrated in FIG. 6 is used, which includes the female mold 51, the male mold 52, and one pressing unit 523. The female mold body 511 of the female mold 51 is configured as an integrated mold body. The pressing side region 529′ of the male mold body 521 of the male mold 52 only has one bore 524. The second outer surface 528 of the male mold body 521 only has one guiding channel 525 extending to access to the bore end 5241 of the bore 524. The actuating member 527 of the pressing units 523 is a compression spring having the inner end 5271 to engage the actuated end 5262 of the plunger 526 and the outer end 5272 opposite to the inner end 5271. The abutment plate 522 is configured to abut against the outer end 5272 of the compression spring so as to facilitate implementation of step e).

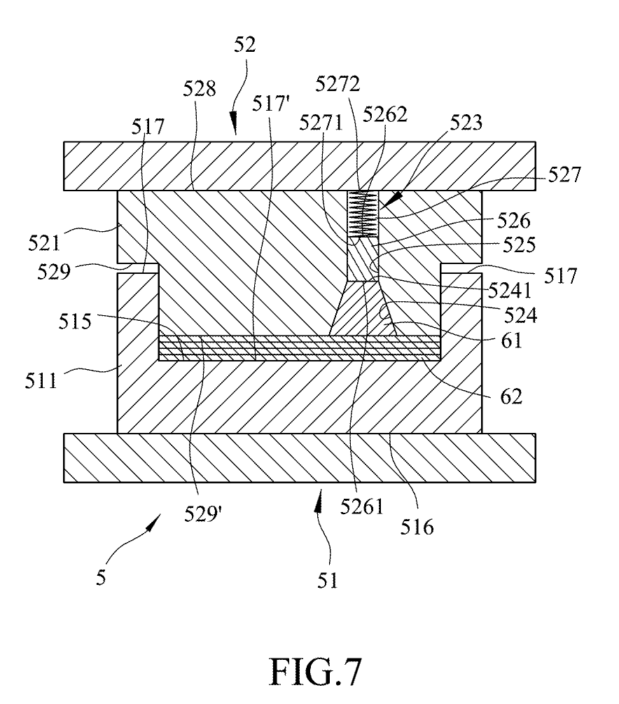

Referring to FIG. 7, a third embodiment of a method for making the molded composite 7 of the prepreg sheet and the molding material 61 according to the disclosure is similar to the second embodiment except that for the mold assembly 5 used in the third embodiment, the male mold 52 is disposed above the female mold 51. Step c) in the third embodiment is implemented by placing the prepreg sheet 62 on the sheet-side region 517′ of the female mold body 511 prior to step b), and inbetween steps b) and c) the molding material 61 is placed on the prepreg sheet 62 to be registered with the bore 524 so as to facilitate implementation of step b).

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for making a molded composite of a prepreg sheet and a molding material, comprising steps of:
a) providing a mold assembly including
a female mold including a female mold body having a first outer surface and a first inner surface which is opposite to the first outer surface and which has a mold cavity extending toward the first outer surface to terminate at a sheet-side region,
a male mold including a male mold body having a second outer surface and a second inner surface which is opposite to the second outer surface and which has a pressing side region configured, in cooperation with the sheet side region to permit the prepreg sheet to be sandwiched therebetween, the pressing side region having at least one bore extending toward the second outer surface to terminate at a bore end and having a shape simulating that of the molding material, the second outer surface having at least one guiding channel extending to access to the bore end of the at least one bore, and
at least one pressing unit including
a plunger which has an engaging end and an actuated end opposite to each other and which is guided by the guiding channel to permit the engaging end to move toward the bore, and
an actuating member configured to press the actuated end of the plunger;
b) disposing the molding material in the at least one bore;
c) interposing the prepreg sheet between the sheet side region of the female mold and the pressing side region of the male mold;
d) combining the female mold with the male mold to permit the prepreg sheet to be sandwiched between the sheet side region of the female mold and the pressing side region of the male mold; and
e) operating the actuating member to press the actuated end of the plunger so as to move the plunger toward the female mold, thereby permitting the engaged end of the plunger to press the molding material against the prepreg sheet.

2. The method according to claim 1, wherein step c) is implemented by placing the prepreg sheet on the pressing side region of the male mold body after step b).

3. The method according to claim 1, wherein step c) is implemented by placing the prepreg sheet on the sheet-side region of the female mold body prior to step b), and wherein inbetween steps b) and c), the molding material is placed on the prepreg sheet to be registered with the bore so as to facilitate implementation of step b).

4. The method according to claim 2, wherein in step a), the female mold body includes
a pair of sliding blocks which are to be disposed on the second inner surface of the male mold body and spaced apart from each other by a predetermined distance which is slightly larger than a dimension of the prepreg sheet, each of the sliding blocks having an outer cam surface; and
a cover including a cover body having the first outer surface and a pair of marginal extensions extending from opposite ends of the cover body, each of the marginal extensions having an inner cam surface configured to mate with the outer cam surface such that when the cover move toward the second inner surface of the male mold body, the sliding blocks are moved to abut against the prepreg sheet by the marginal extensions.

5. The method according to claim 1, wherein the actuating member is a compression spring having an inner end to engage the actuated end of the plunger and an outer end opposite to the inner end.

6. The method according to claim 5, wherein the male mold further includes an abutment plate configured to abut against the outer end of the compression spring so as to facilitate implementation of step e)

7. The method according to claim 1, wherein the molding material is selected from the group consisting of a bulk molding compound and a sheet molding compound.

8. The method according to claim 4, wherein step d) is implemented by disposing the sliding blocks on the second inner surface of the male mold body prior to placing of the prepreg sheet, and subjecting the cover to move toward the second inner surface of the male mold body after placing of the prepreg sheet to permit the sliding blocks to be moved to abut against the prepreg sheet by the marginal extensions.

9. The method according to claim 4, wherein step d) is implemented by disposing the sliding blocks on the second inner surface of the male mold body after placing of the prepreg sheet, and subjecting the cover to move toward the second inner surface of the male mold body after placing of the prepreg sheet to permit the sliding blocks to be moved to abut against the prepreg sheet by the marginal extensions.

10. A molded composite made by the method according to claim 1.
